(19) United States
(12) Patent Application Publication
(10) Pub. No.: US 2007/0165094 A1
(43) Pub. Date: Jul. 19, 2007

(54) Thermal printing apparatus

(75) Inventors: Yoshitaka Matsumura, Miyazaki-gun (JP); Takahisa Tominaga, Miyazaki-gun (JP)

Correspondence Address: OSHA LIANG L.L.P., 1221 MCKINNEY STREET, SUITE 2800, HOUSTON, TX, 77010, US

(73) Assignee: SANAWA NEWTEC CO., LTD., OSAKA-SHI, OSAKA JAPAN (JP)

(21) Appl. No.: 11/587,910

(22) PCT Filed: Mar. 29, 2005
(86) PCT No.: PCT/JP05/05834

§ 371 Date: Oct. 26, 2006

(30) Foreign Application Priority Data
Apr. 26, 2004 (JP) 2004-130043

(51) Int. Cl. B41J 2/375

(52) U.S. Cl. 347/223

(57) ABSTRACT

A thermal printing apparatus (1) includes an erasing unit (51) and a printing unit (52) that are positioned along a paper guide (53). Between the erasing unit (51) and the printing unit (52), cooling fans (46) are located. The erasing unit (51) has an erasing roller (37) for applying heat to thermal recording paper fed by a paper feeding tray (2) while transporting the paper. The paper is heated by the roller 37, and then cooled slowly in the course of being transported, so that an image is erased from the paper. The fans (46) create and direct a current of air to cool the paper transported by the roller (37). Then, the printing unit (52) prints a new image on the paper.

### TECHNICAL FIELD

The present invention relates to a thermal printing apparatus designed to perform image-erasing and printing operations consecutively in a single process.

### BACKGROUND ART

Thermal printing apparatus have been proposed that are designed to erase a printed image from paper, and print an image on the paper, consecutively in a single process through the use of color-developing-type reversible thermal recording paper that includes a leuco dye and a reversible developer (see Patent Literature 1).

A type of such thermal printing apparatus includes: an erasing roller, provided on a paper feeding side of the apparatus, for applying heat to thermal recording paper to erase a printed image from the paper; and a print head provided on a paper output side of the apparatus (see Patent Literature 2). The print head prints an image on thermal recording paper, and the erasing roller erases a printed image from the paper.

Patent Literature 1: JP 2004-106308A

Patent Literature 2: JP 2002-331697A

### DISCLOSURE OF INVENTION

### TECHNICAL PROBLEM

Thermal printing apparatus designed to perform image-erasing and printing operations consecutively in a single process are more convenient than those designed to perform the two operations in two separate processes.

As erasing and printing operations are repeated, however, the heat of the erasing roller (approximately 150° C. to 200° C.) causes a paper transport path, and thermal recording paper being conveyed thereon, to become progressively hotter. The heat prevents the paper from providing sufficient color developing density when the thermal head prints an image thereon.

To provide a solution to the foregoing problem, a feature of the invention is to offer a thermal printing apparatus that ensures sufficient print density.

### TECHNICAL SOLUTION

The thermal printing apparatus according to an aspect of the invention includes: a transport mechanism for transporting thermal recording paper on a transport path; a print head for printing an image of dots on the thermal recording paper being transported on the transport path; erasing means, provided upstream of the print heat along the transport path, for applying heat to the thermal recording paper to erase a printed image therefrom; and cooling means for cooling a portion of the transport path between the print head and the erasing means, as well as the thermal recording paper being transported on the portion of the transport path.

According to another aspect of the invention, the cooling means is a cooling fan for creating and directing a current of air to the portion of the transport path between the print head and the erasing means.

### ADVANTAGEOUS EFFECTS

The thermal printing apparatus according to aspects of the invention includes the cooling means, located midway between the erasing means and the print head, that cools paper and the transport path. Thus, the apparatus provides a solution to the problem of insufficient color developing density due to heat of paper. The apparatus is advantageous in ensuring sufficient print density.

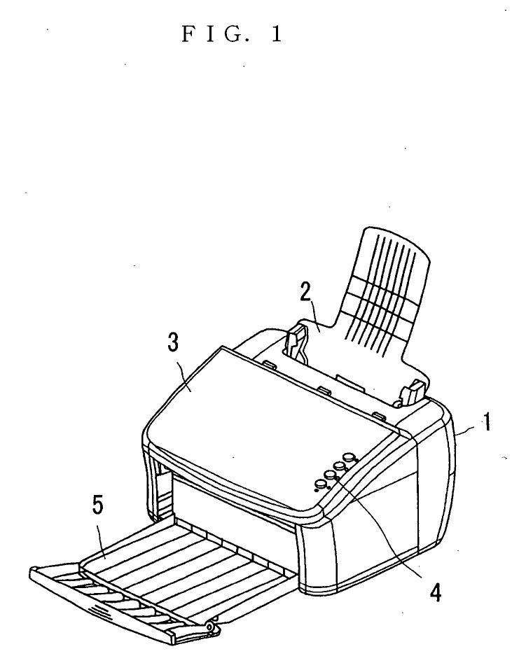

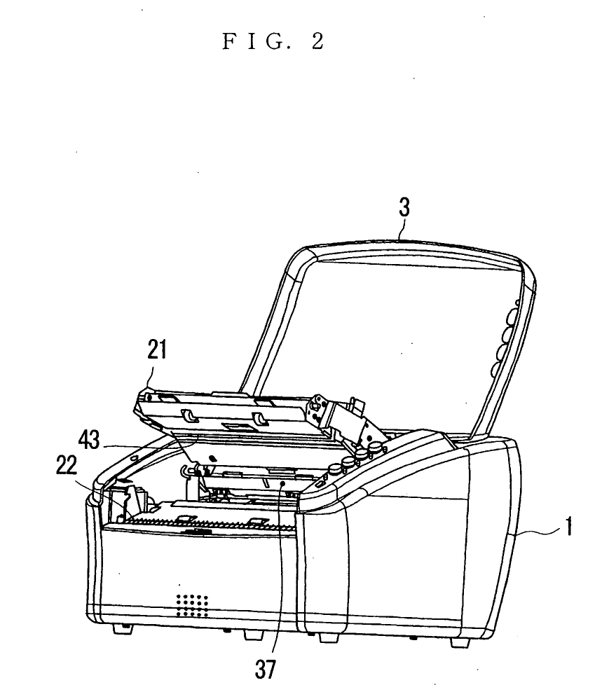

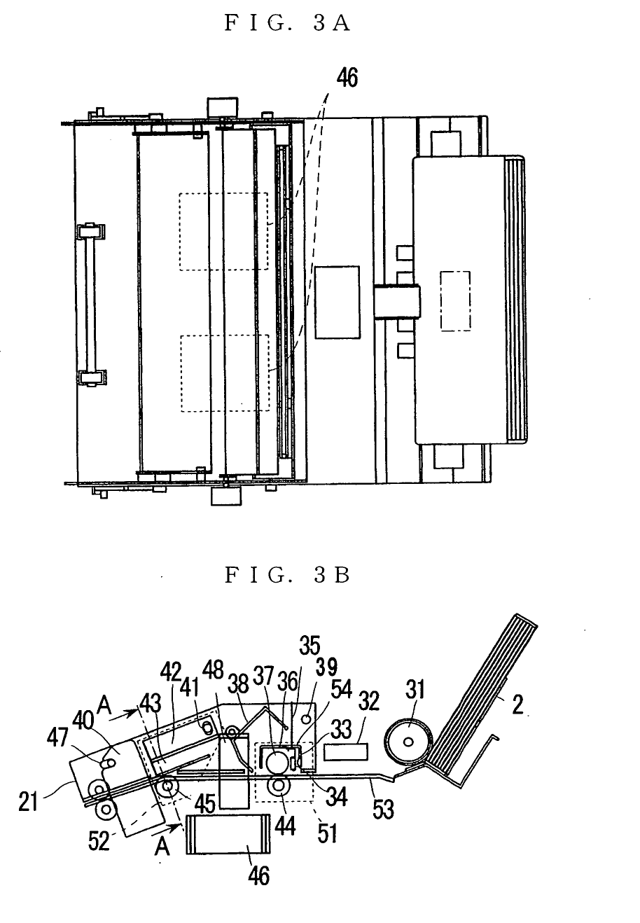

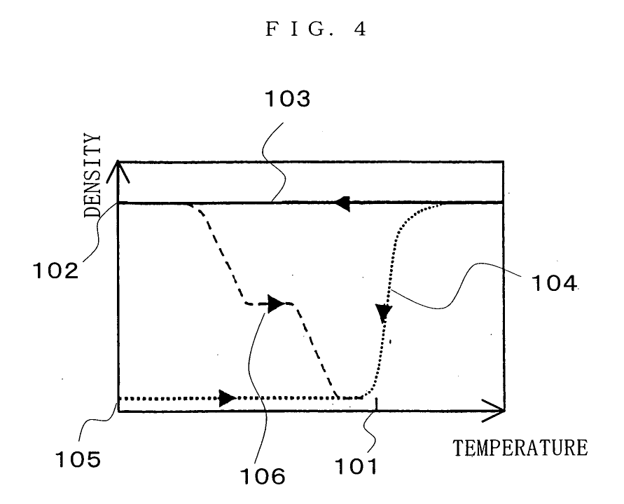

### BRIEF DESCRIPTION OF THE DRAWINGS

[FIG. 1] FIG. 1 is an external view of a thermal printing apparatus according to an embodiment of the invention.

[FIG. 2] FIG. 2 is a view of the apparatus with a top cover in an open position.

[FIG. 3] FIGS. 3A and 3B are a top view and a side view, respectively, of the interior of the apparatus.

[FIG. 4] FIG. 4 is a graph showing a relationship between temperature and color developing density of a reversible heat-sensitive layer of thermal recording paper for use in the apparatus.

### BEST MODE FOR CARRYING OUT THE INVENTION

Referring to the accompanying drawings, a thermal printing apparatus according to several embodiments of the invention will be described below.

FIG. 1 is an external view of a thermal printing apparatus 1 according to an embodiment of the invention. FIG. 2 is a view of the apparatus 1 with a top cover in an open position. FIGS. 3A and 3B are a top view and a side view, respectively, of the interior of the apparatus 1.

Referring to FIG. 3B, the apparatus 1 includes a thermal head 43 and an erasing roller 37.

The head 43 prints an image on thermal recording paper. The roller 37 erases a printed image from thermal recording paper, thereby rendering the thermal recording paper reusable.

Thermal recording paper for use in the apparatus 1 includes a base material, a conventional reversible heat-sensitive layer such as disclosed in Patent Literature 1, and a protective layer. The reversible heat-sensitive layer includes a leuco dye and a reversible developer. The reversible heat-sensitive layer has the properties as described below. When heated to a temperature exceeding a melting point 101 and then cooled rapidly, the reversible heat-sensitive layer is brought to a color-developed state 102 through a route 103. When heated to a temperature exceeding the melting point 101 and then cooled slowly, meanwhile, the reversible heat-sensitive layer is brought to a colorless state 105 through a route 104. The reversible heat-sensitive layer is also brought to the colorless state 105 through a route 106 by being held in the state 102 at a temperature slightly below the melting point 101.

In the present embodiment, thermal recording paper is heated by the roller 37, and then cooled slowly in the course of being transported. Thus, the thermal recording paper is rendered colorless in a transport path from the roller 37 to the head 43, and is then caused to develop color by the head 43.

Repeated use of thermal recording paper, however, results in accumulation of heat in the thermal recording paper and the transport path. The accumulated heat sometimes prevents the thermal recording paper from being discolored properly. A cooling fan is used to cool thermal printing paper in order to avoid the negative effects of such heat accumulation and ensure proper discoloring of thermal recording paper.

Referring to FIG. 1, a paper feeding tray 2 for loading paper is mounted at the upper rear of the apparatus 1. A top cover 3 is provided on top of a casing of the apparatus 1. Inside the casing provided are a paper guide 53, a movable unit 21 where the roller 37 and the head 43 are positioned, and the like. The roller 37, the head 43, and the guide 53 are shown in FIG. 3B. Also, a paper output tray 5 for receiving output paper is mounted on a lower front surface of the apparatus 1.

An operating panel 4 is provided on a right side of the cover 3. When a user performs a controlling action on the panel 4 (such as of selecting printing or erasing operation), thermal recording paper loaded in the tray 2 is automatically fed into the casing; then, an image is printed on, or erased from, the paper; and finally, the paper is output to the tray 5.

Referring to FIG. 2, the cover 3 is in an open position.

The guide 53 is positioned below the unit 21. A bottom surface of the unit 21 and an upper surface of the guide 53 define a paper transport path 22.

The unit 21 is configured to be automatically pivoted upward to expose the path 22, when the cover 3 is opened and then a hook 40 (shown in FIG. 3B) is disengaged.

In the unit 21, the roller 37 and the head 43 are mounted on a rear side (a paper feeding side) and a front side (a paper output side), respectively, so as to face the path 22.

In a printing operation, paper is fed, with the cover 3 and the unit 21 closed, from the tray 2 into the path 22 by a feeding roller 31 (shown in FIG. 3B) provided on an end of the tray 2 adjacent to the guide 53.

The paper is transported from the feeding side to the output side, i.e., from the tray 2 to the tray 5, on the path 22. The head 43 prints an image on the paper in the course of being transported. If the paper has a printed image thereon, the image is erased by the roller 37 arranged upstream of the head 43, i.e., on the feeding side.

When paper becomes jammed in the path 22, the cover 3 is opened and then the unit 21 is raised to expose the path 22, as shown in FIG. 2, for access to the jammed paper.

FIG. 3A and FIG. 3B are a top view and a side view, respectively, of the apparatus 1.

Referring to FIG. 3B, the guide 53, on the upper surface of which paper is transported, extends from a feeding-side end to an output-side end of the apparatus 1.

Along the guide 53, the paper feeding tray 2, the feeding roller 31, an antenna 32, an erasing unit 51, and a printing unit 52 are arranged in that order.

A pair of cooling fans 46 are located below the guide 53 and almost midway between the units 51 and 52. The fans 46 are arranged parallel to an axis of rotation of the roller 31 and symmetrically with respect to a center line of the guide 53 extending along a paper feeding direction.

The fans 46 may be located either above or below the guide 53. Alternatively, one of the fans 46 may be located above the guide 53, and the other below the same.

The unit 51 includes the erasing roller 37 and an erasing roller holder 36. The roller 37 applies heat to paper to erase an image from the paper. The holder 36 is provided with a panel for covering the roller 37. The panel has a first portion, a second portion, and a third portion, to face the front (an output side), rear (a feeding side), and top (an opposite side to a side for contact with thermal paper) of the roller 37, respectively. The unit 51 also includes a platen roller 44, an elastic member 33, a felt strip 34, and a felt strip holder 35. The roller 44 is placed to face the roller 37. The member 33 is attached to the first portion of the panel. The strip 34, which is in contact with the roller 37, serves as a cleaning member. The strip 34 is supported by a holder 35 that is placed parallel to the roller 37.

The unit 52 includes the thermal head 43, a thermal head holder 42, and a platen roller 45. The head 43 prints an image on thermal recording paper that comes in contact therewith. The head 43 is supported by the holder 42. Opposite the head 43, there is positioned a platen roller 45. The holder 42 is supported at a feeding-side end by a pin 41.

Referring to FIG. 3B, the roller 37, a cover 38, the holder 42, and the head 43 are positioned in the unit 21. The unit 21 is pivotably supported at a feeding-side end by a pin 39 provided above the unit 51.

When the unit 21 is in its closed position, the hook 40 is engaged with a pin 47 provided in the unit 21, thereby holding the unit 21 at a predetermined distance (approximately 2 to 3 mm) away from the guide 53.

The hook 40 is formed integral with the guide 53 at a right angle thereto. The hook 40 is positioned in front of the head 43 (i.e., to the output side of the head 43). The hook has a top side with a slant, and an output-side lateral side with a depression for fitting the pin 47.

The pin 47 is urged toward the feeding side of the apparatus 1 by a not-shown torsion spring. The pin 47 is placed in a slit in such a manner as to be movable along the length of the slit toward the output side of the apparatus 1. Pulling the pin 47 toward the output side disengages the pin 47 from the hook 40, so that the unit 21 is automatically pivoted upward. Also, the pin 47 extends horizontally through the unit 21.

As the unit 21 is being closed, the pin 47 is moved, along the slant of the hook 40, to the depression. Then, the pin 47 is urged into the depression by the torsion spring, thereby holding the unit 21.

The roller 37 has high temperature (approximately 150° C. to 200° C.) and, thus, is more likely to cause burn injury to an operator trying to remove jammed paper. This is because, in the event of paper jam, an operator is more likely to inadvertently touch the roller 37 when raising the unit 21 and reaching for jammed paper. The cover 38 is thus provided in order to prevent burn injury to an operator. A plate 48 is provided that prevents protrusion of the cover 38 onto the path 22.

Additionally, the antenna 32 is positioned midway between the rollers 31 and 37 for the purpose of detecting thermal recording paper with an IC tag attached. The antenna 32 detects such thermal recording paper through communication with the attached IC tag.

The apparatus 1 is designed to perform erasing and printing operations consecutively in a single process. In this process, thermal recording paper loaded in the tray 2 is conveyed to the roller 37 by the roller 31. The roller 37 erases an image, if any, from the paper. At this time, the roller 37 has high temperature (approximately 150° C. to 200° C.). Thus, the paper conveyed by the roller 37, as well as the guide 53, is also heated to high temperature.

The fans 46 located between the roller 37 and the head 43 create and direct a current of air to cool the paper and the guide 53. This prevents the negative effects of heat accumulation and ensures a continued good quality of printing.

Then, the paper is conveyed to the head 43. The head 43 prints an image on the paper.

As thus far described, the apparatus 1 ensures a continued good quality of printing through provision of the fans 46 midway between the roller 37 and the head 43 for cooling thermal recording paper and the guide 53.

1] A thermal printing apparatus comprising:
a transport mechanism for transporting thermal recording paper on a transport path;
a print head for printing an image of dots on the thermal recording paper being transported on the transport path;
erasing means, provided upstream of the print heat along the transport path, for applying heat to the thermal recording paper to erase a printed image therefrom; and
cooling means for cooling a portion of the transport path between the print head and the erasing means, as well as the thermal recording paper being transported on the portion of the transport path.

2] The thermal printing apparatus according to claim 1,
wherein the cooling means is a cooling fan for creating and directing a current of air to the portion of the transport path between the print head and the erasing means.
